(19) United States
(12) Patent Application Publication
(10) Pub. No.: US 2010/0185459 A1
(43) Pub. Date: Jul. 22, 2010

(54) SYSTEMS AND METHODS FOR X-RAY IMAGE IDENTIFICATION

(76) Inventors: German Guillermo Vera, Waukesha, WI (US); Ping Xue, Pewaukee, WI (US); John Robert Lamberty, Oconomowoc, WI (US)

Correspondence Address: DEAN D. SMALL;THE SMALL PATENT LAW GROUP LLP, 225 S. MERAMEC, STE. 725T, ST. LOUIS, MO, 63105, US

(21) Appl. No.: 12/355,502

(22) Filed: Jan. 16, 2009

(51) Int. Cl. G06F 19/00; G01T 1/24

(52) U.S. Cl. 705/3; 250/370.09

(57) ABSTRACT

Systems and methods for x-ray image identification are provided. The systems and methods associate patient information with image information. The method includes acquiring patient information from an identification member external to the digital x-ray detector and storing the patient information within the x-ray detector or on an image. The method further includes associating the patient information with the images acquired by the x-ray imaging system and communicating the acquired images with associated information to a host system when the x-ray detector is connected to the host system.

### BACKGROUND OF THE INVENTION

This invention relates generally to diagnostic imaging systems, and more particularly to x-ray imaging systems.

In diagnostic medical imaging it is important to associate patient data with image data. In particular, it is important to be able to associate acquired image data with a patient when subsequently reviewing and analyzing the image data. Some imaging systems are connected to the review station or image storage system such that patient data is easily associated with image data. For example, in digital detector x-ray systems, the scanning portion of the system, including the detector is connected to a controller such that processing is performed by the controller to acquire x-ray image data. The controller typically includes a console for use by a user and processing components to process the received x-ray image data. Information regarding the patient being imaged is typically stored within the system and then associated or saved in connection with images acquired for a patient. A user typically provides an input indicating which patient is being scanned by the scanning portion, such as by entering the person's name or selecting the name from a list or database. Thus, patient information is associated with acquired images within the processing components of the controller connected to the scanning portion. For example, a Digital Imaging and Communications in Medicine (DICOM) header may be used to communicate the patient information.

However, if the digital x-ray system is portable or remote from the controller, or for example, if an existing film type x-ray detector system is retrofitted with a digital detector, the system is not always in communication with another device, for example, a controller or host system. Accordingly, patient information to associate with acquired images is not available. Thus, a user must manually keep a list or otherwise keep track of the acquired images (stored within the scanning portion) and the patient corresponding to the images. This process can become time consuming and may lead to possible errors in associating images with the wrong patient, which can lead to improper diagnosis.

### BRIEF DESCRIPTION OF THE INVENTION

In accordance with one embodiment, a method for associating patient information with images acquired by an x-ray imaging system having a digital x-ray detector is provided. The method includes acquiring patient information from an identification member external to the digital x-ray detector and storing the patient information within the x-ray detector. The method further includes associating the patient information with the images acquired by the x-ray imaging system and communicating the acquired images with associated information to a host system when the x-ray detector is connected to the host system.

In accordance with another embodiment, an x-ray detector is provided that includes a digital detector element and a pocket coupled to a front surface of the digital detector element. The pocket covers at least a portion of the digital detector element and is configured to receive an identification card therein.

In accordance with yet another embodiment, an x-ray detector is provided that includes a housing and a digital element within the housing. The x-ray detector further includes a device coupled to the housing. The device is configured to acquire identifying information for a patient or to provide identifying information for an image.

### BRIEF DESCRIPTION OF THE DRAWINGS

FIG. 1 is a block diagram of an x-ray imaging system in connection with which various embodiments of the invention may be used,

FIG. 2 is a side elevation view of a mobile x-ray system in connection with which various embodiments of the invention may be used.

FIG. 3 is a perspective view of an x-ray detector formed in accordance with an embodiment of the invention

FIG. 4 is an image having identifying information formed as part of the image in accordance with various embodiments of the invention.

FIG. 5 is a perspective view of an x-ray detector formed in accordance with another embodiment of the invention.

FIG. 6 is a block diagram of an x-ray detector formed in accordance with an embodiment of the invention.

FIG. 7 is a perspective view of an x-ray detector formed in accordance with another embodiment of the invention.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments of the invention provide methods and systems for associating one or more x-ray images with information related to the object being imaged, such as a patient. For example, various embodiments of the invention allow patient information to be associated with x-ray images in systems where no communication is provided between a controller or host system that would otherwise be used to associate the information with acquired images. Although the various embodiments may be described in connection with a portable imaging system, the various embodiments are not so limited. Moreover, the various embodiments also may be used in connection with systems that are provided with a communication link to controller, central processor or host, and may be used when the communication is, for example, lost or down, or as a secondary check when associating images with patient information. Thus, the various embodiments of the invention may be used in connection with any type of x-ray system, especially x-ray systems having a digital x-ray detector.

It should be noted that like numerals represent like parts in the various embodiments described herein.

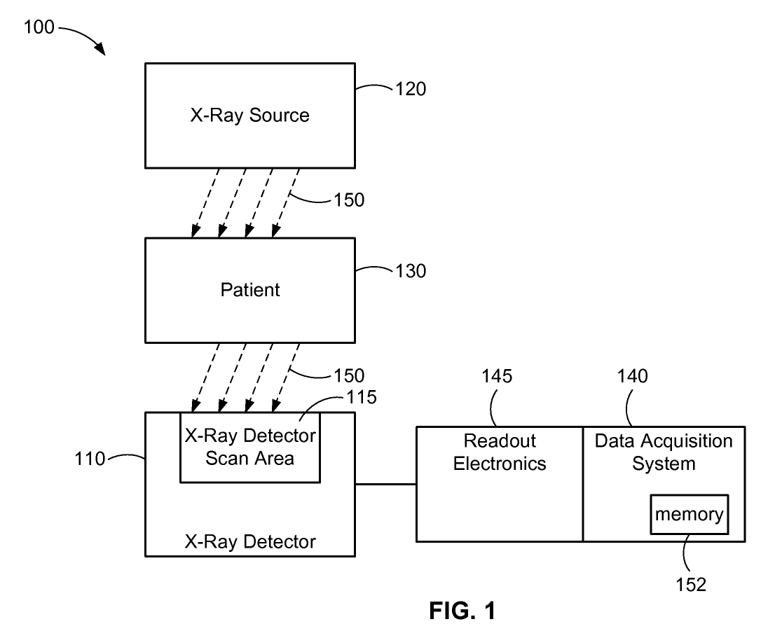

FIG. 1 illustrates an imaging system 100 in connection with which various embodiments of the invention may be used. For purposes of illustration, the imaging system 100 is described as an x-ray system having a digital detector. The imaging system 100 generally includes an x-ray source 120 and x-ray detector 110 that may be formed of one or more detector cells to define an x-ray detector scan area 115, which forms a digital x-ray sensor. An object, such as a patient 130 is positioned between the x-ray source 120 and the x-ray detector 110. The imaging system 100 also includes a data acquisition system 140 with readout electronics 145 that are connected to the x-ray detector 110.

In operation, and as is known, x-ray signals 150 that pass through the patient 130 are converted into digital images, with the images digitized into a matrix of pixels with each pixel digitally coded. The x-ray detector 110 may be formed of any material or combination of materials that detects x-rays and converts the detected x-rays to electrical signals that are used to form an image. Moreover, other types of detector structures may be used, for example, a slot scan type of detector, a tiled CCD array, a direct conversion detector or a computed radiography detector.

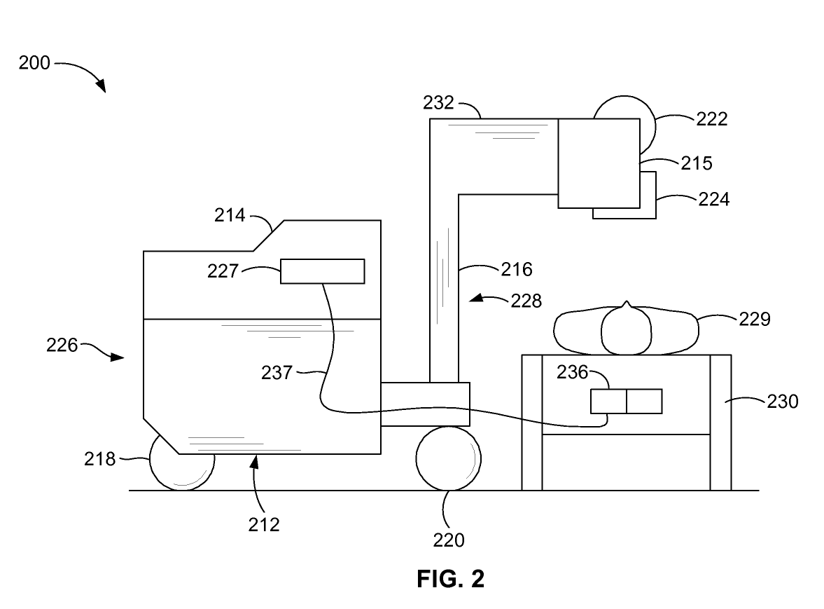

Various embodiments of the invention may be used to associate patient data and image data in different types of diagnostic imaging system, for example, x-ray imaging systems. For example, the various embodiments may be implemented in connection with a mobile x-ray system 200 as shown in FIG. 2, which may be used in the medical field or in other fields. It should be noted that the various embodiments are not limited to a particular type of imaging system, but may be used in connection with any type of imaging system wherein data, particularly patient data is to be associated with image data. For example, the various embodiments may be used in connection with fixed room imaging systems or in general, with any system that acquires x-ray or other image data.

Referring now to FIG. 2, the system 200 has a wheeled motorized drive assembly 212 and an operator console 214 that may be supported by the drive assembly 212. The motorized drive assembly 212 has rear drive wheels 218 (one wheel is shown) at a rear end 226 of the system 200 and front wheels 220 (one wheel is shown) at a front end 228 of the system 200. However, it should be noted that more or less wheels or other moveable members may be provided.

A column 216 or other support member is attached to, and extends from, the drive assembly 212 and may be capable of rotating or swiveling with respect to the drive assembly 212. Additionally, an arm 232 fixed to the column 216 may also telescope with respect to the column 216, allowing components mounted at an outer end of the arm 232 to be moved closer to or further away from the column 216. A radiation source, such as an x-ray source assembly 215, is attached to the outer end of the arm 232 and includes an x-ray tube housing 222 containing an x-ray source (not shown). A collimator 224 may be attached to the tube housing 222 and is rotatable with respect to the tube housing 222. An x-ray detector 236 (which in this embodiment is a digital x-ray detector) detects x-rays and may communicate with an imaging controller 227 wirelessly or over a cable 237.

The object 229 (e.g., patient) to be imaged and in connection with which data is to be associated may be lying on a bed or table 230, but may be standing. Once the system 200 is positioned near the table 230, the column 216 is swiveled or rotated to position the x-ray source assembly 215 over the object 229. The detector 236 is positioned on the opposite side of the subject 229.

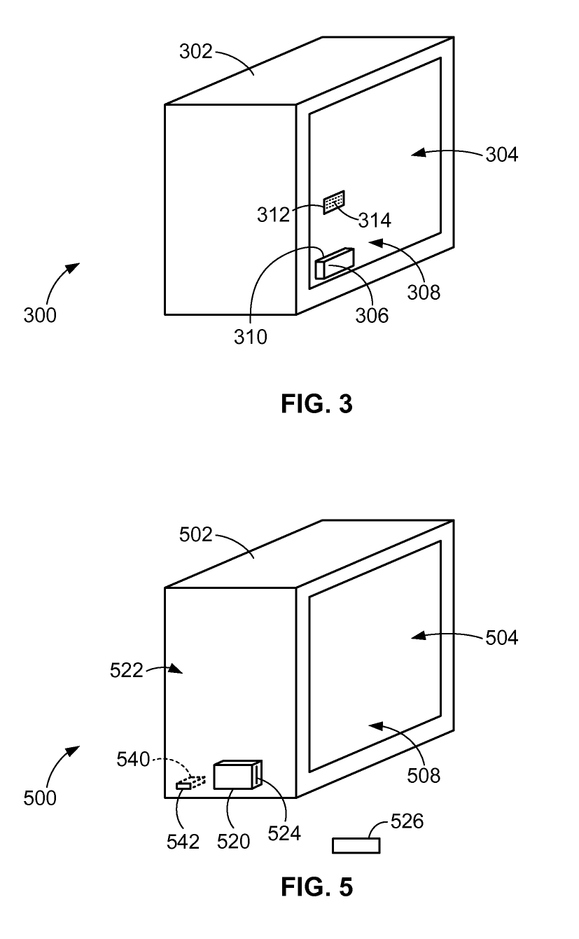

Various embodiments of the invention may include an x-ray detector 300 as shown in FIG. 3 having a housing 302 that holds or has therein a detector element 304. The detector element 304 is any suitable x-ray detection element, such as, but not limited to, any type of digital detector element as described herein, for example, a semiconductor, and/or the like. In this embodiment, the x-ray detector 300 includes a holder, which is configured as a pocket 306 positioned on a front surface 308 of the x-ray detector 300. The pocket 306 is positioned to cover a portion of the detector element 304, for example, positioned in a lower left corner of the detector element 304. However, it should be noted that the pocket 304 may be positioned at any location along the front surface 308 of the x-ray detector 300 as long as the pocket 304 overlays at least portion of the detector element 304. The pocket generally includes an open end 310, which is illustrated at the top of the pocket 306. However, the open end 310 also may be provided instead of or in addition to on the top of the pocket 306, on one or both of the sides of the pocket 306.

It should be noted that the pocket 306 may be permanently affixed or removably connected to the x-ray detector 300. For example, the pocket 306 may be adhered to the x-ray detector 300 or may be connected thereto by a removable fastener, such as a hook-and-loop fastener. It also should be noted that the pocket 306 may be formed from any material that is transparent to x-rays. The material from which the pocket 306 is formed may also be transparent, such that the contents of the pocket 306 are visible or may be opaque and colored for easy identification and location on the x-ray detector 300.

The pocket 306 also may be shaped and sized in different dimensions and proportions. Accordingly, although the pocket 306 is illustrated as rectangular in shape, the pocket may be different shaped, for example, as a square, triangle, etc. In one embodiment, the pocket 306 is rectangular in shape having dimensions of about two inches by about one inch. The pocket 306 is generally sized and shaped to be complementary to and for receiving therein an identification member, which in this embodiment is an identification card 312. The identification card 312 includes identifying information 314 recorded or printed thereon using a radio opaque substance, for example, a radio opaque ink or dye. For example, patient identification information (e.g., patient name and identification number) may be printed or handwritten thereon using a radio opaque marker or printer. However, any type of information, for example, date, location, etc. information or image information (e.g., logo, picture, etc.) may be provided on the identification card 312. The information may be preprinted on the identification card 312 or may be provided thereon prior to the exam by handwriting the information using a radio opaque marker.

It should be noted that the identification card 312 is formed from a material so that the information printed or handwritten on the identification card 312, such as with radio opaque ink or dye, is captured in the image. Moreover, the identification card 312 may be replaced with any type of identifier or marker.

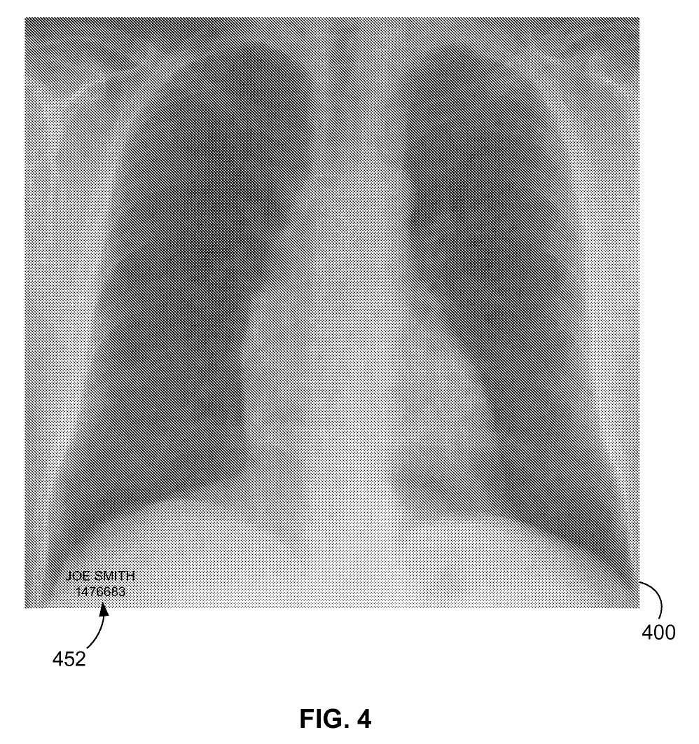

Thus, as illustrated in FIG. 4, any information provided on the identification card 314 becomes part of an image 400. For example, as shown in the lower left portion of the image 450, identification information 452 is part of the image, which includes, in this example, the patient name and a patient identification number.

In another embodiment, a x-ray detector 500 includes a scanner 520 on a side 522 of the x-ray detector 500, for example, mounted to the side 522 of the housing 502 as shown in FIG. 5. The scanner 520 may be any scanning device, for example, a bar code reader. The scanner 520 may include a slot 524 for inserting an identification card 526 that includes identifying information about a patient as described herein. However, in this embodiment, the identifying information is encoded in a bar code for reading when the identification card 526 is inserted into the slot 524. Optionally, the scanner 520 may include an optical reader (not shown) as is known to read the identifying information without having to insert the identification card 526 into the scanner 520. The scanner 520 also may be provided as part of the pocket 506.

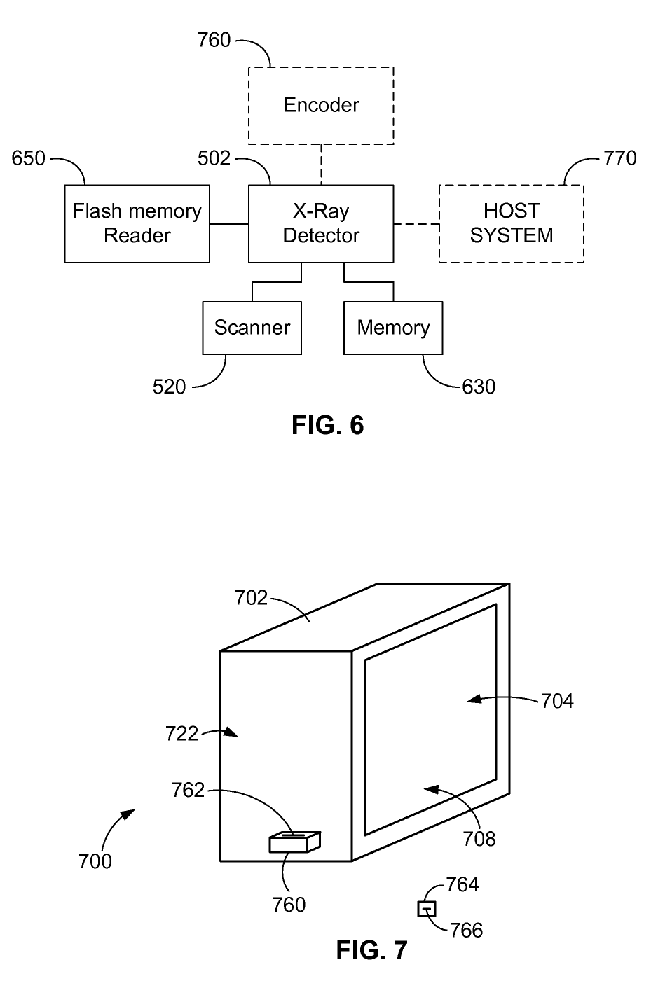

It should be noted that the scanner 520 may be any type of known scanning device, for example, any type of optical or radio frequency scanner that is capable of reading identifying information from the identification card 526. Optionally, the scanner 520 may be a video recording camera that obtains an image of the identifying information or patient data, for example, in the form of text characters. The identifying information is then stored in a memory 630 as shown in FIG. 6, which may be integrated with or separate from the x-ray detector 500. For example, the memory 630 may be a data storage drive that is integrated with or removably inserted within the x-ray detector 500 or may be a removable memory element, for example, a flash memory data storage device 540 that is inserted within the slot 542 on the side 522 of the x-ray detector 500 (all shown in FIG. 5). The slot 542 forms part of a flash memory reader 650.

The memory 630 stores the identifying information such that the identifying information is associated with acquired x-ray image data. For example, each time a new patient is scanned, and in particular, prior to imaging the patient, the identification card 526 is scanned by the scanner 520 and the information stored and associated with any images acquired during a scan. Thereafter, when another identification card 526 is scanned, any images thereafter are associated with the identifying information from that identification card 526. For example, a memory location identifier or address(es) may be associated with the identifying information, such that any acquired x-ray image data is stored in that memory location or address. Accordingly, when the x-ray detector 500 is connected to a host system, the images may be communicated with the associated identifying information to associate the acquired images with a patient. It should be noted that the identification card 526 may be scanned before, during or after image acquisition.

It should be noted that the identifying information acquired by the scanner 520 optionally may be printed on the images similar to that shown in FIG. 4. Also, it should be noted that the scanner 520 may be a handheld device that is connected, for example, removably connected to the x-ray detector 500, which connection may be wired or wireless and that performs scanning operations to obtain identifying information from the identification card 526 or other tag that may be connected to the patient (e.g., a bar-coded wristband). It further should be noted that the scanner 520 is not limited to mounting on the side 522 of the x-ray detector 500, but may be mounted, for example, on the top or back of the x-ray detector 500, or built into the detector 500 at a particular location.

Optionally, instead of an identification card 526, a list, which includes barcodes or other scanable information may be provided on one or more sheets such that scanable information is presented to the scanner 520 (e.g., swiped or waved in front of the scanner 520) as each new patient is to be scanned. For example, a sheet of paper may list the identifying information for every patient to be imaged in one day, with a separate barcode provided for each person on the sheet of paper.

In another embodiment as shown in FIG. 7, or optionally, an x-ray detector 700 may include an encoder 760, which may be provided on a side 722 of the x-ray detector 700. The encoder 760 includes a slot 762 for inserting a blank identification card 764 (e.g., electronic card) and on which patient information is encoded to provide, for example, an additional record with identifying information to associate a scan with a patient. The encoder 760 may be any type of encoder, for example, a magnetic encoder that encodes a magnetic strip 766 on the blank identification card 764. The encoder 760, optionally, may be a printing device that prints information on the blank identification card 764

Thus, various embodiments of the invention provide different means for associating identifying information (e.g., patient data) with acquired images at the time of image acquisition. Accordingly, multiple images may be acquired before the detector has to be connected to a host system 770 as shown in FIG. 6. Moreover, the various embodiments may be implemented as part of an upgrade or retrofit kit when film type detector systems (e.g., mobile film type detector units) are upgraded with digital detectors.

In accordance with various embodiments of the invention, therefore, patient data may be “burned” into an image during the image acquisition process. In other embodiments of the invention, a blank identification card may be provided and image data is then encoded on the card that is carried with the patient. For example, the identification card may be encoded with image numbers (e.g., 0018, 0019 and 0020), which correspond to the image numbers for the images acquired of the patient. Alternatively, a medical record or file may be carried with the patient and the image data encoded on the medical record to update the patient record. Also, it should be noted that the images may be written directly to the identification card, for example, magnetically encoded or stored within a memory of the identification card. For example, the identification card may include a flash memory or removable flash drive.

As another example, all or some of the data from the exam may or may not be included on the identification card. For example, exam and/or test events may be encoded on the identification card. As another example, confirmation of one or more of a test and exam may be encoded on the identification card, for example, equivalent to a check mark on a list of patient exams already stored on the identification card.

Additionally, variations and modifications are contemplated. For example, a keyboard, touchscreen, touch-pad or other user input may be connected to the detector for inputting or selecting identifying information. Also, the various readers and scanners may be provided using different types of reading or scanning devices, for example, based on the type of identifying information to read or scanned.

Some embodiments of the present invention provide a machine-readable medium or media having instructions recorded thereon for a processor or computer to operate an imaging apparatus to perform one or more embodiments of the methods described herein. The medium or media may be any type of CD-ROM, DVD, floppy disk, hard disk, optical disk, flash RAM drive, or other type of computer-readable medium or a combination thereof.

The various embodiments and/or components, for example, the processors, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

As used herein, the term “computer” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An x-ray detector comprising:
a digital detector element; and
a pocket coupled to a front surface of the digital detector element and covering at least a portion of the digital detector element, the pocket configured to receive an identification card therein.

2. An x-ray detector in accordance with claim 1 wherein the pocket is coupled to a corner of the front surface, wherein the front surface is an x-ray detecting surface.

3. An x-ray detector in accordance with claim 1 wherein the pocket comprises an x-ray transparent material.

4. An x-ray detector in accordance with claim 1 further comprising an identification card constructed of a material to allow for the transfer of information from the identification card to an image using x-ray exposure.

5. An x-ray detector in accordance with claim 1 further comprising an identification card including radio opaque identifying information printed thereon.

6. An x-ray detector in accordance with claim 5 wherein the identifying information comprises patient information.

7. An x-ray detector in accordance with claim 5 wherein the identifying information comprises preprinted information.

8. An x-ray detector comprising:
a housing;
a digital element within the housing; and
a device coupled to the housing, the device configured to acquire identifying information for a patient or to provide identifying information for an image.

9. An x-ray detector in accordance with claim 8 wherein the device comprises a barcode reader configured to read a barcode encoded with the identifying information.

10. An x-ray detector in accordance with claim 9 further comprising an identification card including the barcode.

11. An x-ray detector in accordance with claim 9 further comprising a patient bracelet including the barcode.

12. An x-ray detector in accordance with claim 8 further comprising a memory for storing the acquired identifying information.

13. An x-ray detector in accordance with claim 12 wherein the memory comprises a flash memory and the housing comprises a slot for receiving therein the flash memory.

14. An x-ray detector in accordance with claim 8 wherein the device comprises a camera.

15. An x-ray detector in accordance with claim 8 wherein the device is removably coupled to the housing.

16. An x-ray detector in accordance with claim 8 wherein the device is coupled to one of a side and a back of the housing.

17. An x-ray detector in accordance with claim 8 further comprising a device configured to transfer the identifying information to an identification card.

18. An x-ray detector in accordance with claim 17 wherein the device comprises a magnetic encoder that encodes a magnetic strip on the identification card.

19. An x-ray detector in accordance with claim 8 further comprising device configured to encode one of exam and test events on an identification card.

20. An x-ray detector in accordance with claim 19 wherein the device is configured to encode confirmation of one or more of a test and exam on the identification card.

21. An x-ray detector in accordance with claim 8 wherein the device comprises a barcode reader configured to read a barcode encoded with the identifying information and further comprising a sheet having a plurality of barcodes containing information corresponding to a plurality of patients.

22. A method for associating patient information with images acquired by an x-ray imaging system having a digital x-ray detector, the method comprising:
acquiring patient information from an identification member external to the digital x-ray detector;
storing the patient information within the x-ray detector;
associating the patient information with the images acquired by the x-ray imaging system; and
communicating the acquired images with associated information to a host system when the x-ray detector is connected to the host system.
